(19) United States
(12) Patent Application Publication
(10) Pub. No.: US 2026/0087731 A1
(43) Pub. Date: Mar. 26, 2026

(54) Spatial Nonuniformity and Shading Effects Mitigation Using Machine-Learning Models

(71) Applicant: Advanced Micro Devices, Inc., Santa Clara, CA (US)

(72) Inventor: Rastislav Lukac, San Jose, CA (US)

(73) Assignee: Advanced Micro Devices, Inc., Santa Clara, CA (US)

(21) Appl. No.: 18/898,552

(22) Filed: Sep. 26, 2024

(51) Int. Cl. G06T 15/80

(52) U.S. Cl. CPC G06T 15/80

(57) ABSTRACT

Systems and techniques for spatial uniformity improvements using machine-learning models are described. Machine-learning models or other artificial intelligence training and inference techniques are used to improve scene-lighting estimations in complex illuminant conditions (e.g., mixed lighting and dynamic environments) and more accurately apply correction parameters to each image for picture and video applications. In one example, executable code for a computational task uses a trained machine-learning model to estimate scene lighting conditions. Correction parameters are then determined based on the estimated lighting conditions and applied to the image to reduce spatial nonuniformity and shading effects. In this way, the described techniques overcome spatial nonuniformity and shading effects present in camera systems of many mobile devices by improving the lighting-condition approximations and subsequent determinations of correction parameters, resulting in improved image and video quality and better user experiences in videoconferencing and photography.

### BACKGROUND

Camera systems are expected to reliably operate in a wide range of lighting conditions to take pictures and videos (e.g., for videoconferencing). However, as the bezel thickness and the form factor allotted for camera systems in mobile devices (e.g., laptops and smartphones) continue to decrease, spatial nonuniformity and shading effects significantly limit image quality. Conventional techniques for improving spatial uniformity and shading effects in camera images are generally insufficient to address mixed lighting and dynamic environments encountered by laptops and smartphones, thus producing images and videos with serious quality degradation.

### BRIEF DESCRIPTION OF THE DRAWINGS

FIG. 1A is a block diagram of a processing system configured to execute one or more applications in accordance with one or more implementations.

FIG. 1B is a block diagram of a non-limiting example system having a device that implements a camera system and processors to mitigate spatial nonuniformity and shading effects in captured images and video using machine-learning models.

FIG. 2 is a block diagram of a non-limiting example procedure that illustrates techniques for improving the spatial uniformity of camera captures using machine-learning models.

FIG. 3 is a block diagram of a non-limiting example system showing device components employed to mitigate spatial nonuniformity and shading effects in camera captures using machine-learning models.

FIG. 4 is a block diagram of a non-limiting example procedure that illustrates techniques to optimize the training of machine-learning models for spatial uniformity improvements in digital images and video.

FIG. 5 is a block diagram of a non-limiting example procedure that illustrates a stepwise algorithm for improving the spatial uniformity of digital images and video using machine-learning models.

### DETAILED DESCRIPTION

The surged presence and use of mobile devices with cameras, including smartphones, tablets, and laptops, has increased the popularity and audience for photography. In recent years, smartphones have been increasingly used to take pictures and record videos due to their availability, improved image quality, and image-driven social media applications. Similarly, laptops have been extensively used for videoconferencing, especially as the number of remote workers has significantly increased. Accordingly, the demand for better image and video quality has grown recently.

Although the camera systems in many mobile devices have dramatically improved in the past few years, image quality for certain uses (e.g., videoconferencing) remains a challenge. For example, user experience for videoconferencing is frequently affected by issues with automatic exposure (e.g., face brightness), white balance (e.g., skin tone accuracy), spatial uniformity (or shading), color appearance, sharpness, and temporal noise. Spatial nonuniformity of an image, for example, is due to variations in the pixel response across an array of pixels of the camera sensor(s) caused by optics, thermal effects, and light leaks. Spatial nonuniformity and shading effects are especially critical because they impact the overall image quality in terms of luminance and color shading effects and the effectiveness of other image processing steps (e.g., noise reduction, white-balancing, and color rendering). The camera systems in many mobile devices, especially laptops, are more susceptible to spatial nonuniformity and shading effects than other cameras due to thin bezels and high-resolution sensor trends. These issues will be further exacerbated as the allocated dimensions for user-facing cameras continue to shrink.

Conventionally, the optical system of high-end camera systems includes several glass lenses to converge light, enhance sharpness, reduce color and optical distortion, block stray light, and correct the light axis. With camera sensors including millions of tiny pixels, a series of lenses generally converges light, enhances sharpness, reduces color and optical distortion, compensates for light loss due to pixel circuitry, and corrects the angle of incident light, especially towards the edges of the pixel array. Modern design trends in laptop sensor modules, however, have reduced the number of lenses to three or fewer plastic lenses, which typically have lower optical quality in comparison to glass lenses, to reduce costs and physical sizing. As a result, many camera systems face image-quality challenges, which are further magnified by shading dependencies on lighting conditions (e.g., color temperature and spectral distribution of the light), scene brightness, mixed lighting from different lighting sources, and infra-red components.

Despite recent advances in camera technology to address many image-quality issues, spatial nonuniformity and shading effects caused by poor optics, thermal effects, and light leaks are still common, especially in laptop and tablet devices, and can significantly degrade video quality. Therefore, camera systems usually attempt to mitigate these degradations using correction factors obtained from calibrations to adjust the image at the pixel level. Unfortunately, this approach often comes up short in more complex scenarios due to calibration limitations, light source estimation errors, and mismatches between calibration conditions and actual scene conditions.

To address these shortcomings, systems and techniques for mitigating spatial nonuniformity and shading effects using machine-learning or artificial intelligence (AI)-based models are described. The techniques leverage the learning capabilities of neural networks and other suitable approaches to analyze and estimate the scene lighting conditions more accurately and efficiently. In addition, the techniques utilize the adaptive decision-making process to determine correction parameters for each image based on the detected lighting conditions. The machine-learning models also utilize cost functions pertinent to spatial uniformity to produce confidence scores, blending maps, or correction factors to overcome limitations in conventional techniques, improve spatial uniformity, and reduce shading effects. The improved image and video quality leads to better user experiences in videoconferencing and photography, thus enhancing the value of mobile devices.

In some aspects, the techniques described herein relate to an apparatus comprising one or more processors configured to: determine, for one or more images, correction parameters to mitigate spatial nonuniformity and shading effects based on an estimate of scene lighting conditions of the one or more images and apply the correction parameters to the one or more images to generate one or more corrected images.

In some aspects, the techniques described herein relate to an apparatus wherein a machine-learning model determines the estimate of scene lighting conditions of the one or more images by associating the scene lighting conditions to multiple shading profiles and providing a confidence value for each shading profile of the multiple shading profiles.

In some aspects, the techniques described herein relate to an apparatus wherein the correction parameters are determined based on at least one of a subset of the multiple shading profiles with highest confidence values; or the multiple shading profiles having confidence values above a predetermined threshold value.

In some aspects, the techniques described herein relate to an apparatus wherein at least one of the estimate of scene lighting conditions, confidence values, or the correction parameters determined by the machine-learning model are combined with at least one of another estimate of scene lighting conditions, other confidence values, or other correction parameters, respectively, determined by a second machine-learning model different from the machine-learning model.

In some aspects, the techniques described herein relate to an apparatus wherein the correction parameters are determined by applying adaptive weights to each correction parameter associated with each shading profile of a subset of the multiple shading profiles, the adaptive weights obtained by normalizing each confidence value with a sum of confidence values for the subset of the multiple shading profiles.

In some aspects, the techniques described herein relate to an apparatus wherein the correction parameters are applied to the one or more images per pixel location or per one or more blocks of pixel values of the one or more images.

In some aspects, the techniques described herein relate to an apparatus wherein the one or more processors comprise multiple processors, and a single processor of the multiple processors employs a machine-learning model to determine the estimate of scene lighting conditions or determine the correction parameters.

In some aspects, the techniques described herein relate to an apparatus wherein the one or more processors are further configured to compare image statistics of the one or more images to one or more predetermined thresholds, and in response to the image statistics satisfying the one or more predetermined thresholds, determine the estimate of scene lighting conditions and determine the correction parameters using a machine-learning model.

In some aspects, the techniques described herein relate to a device comprising a camera system with one or more sensors and one or more processors, the one or more processors being collectively configured to obtain image data for one or more images from the one or more sensors; determine, for the one or more images, correction parameters to address spatial nonuniformity and shading effects based on an estimate of scene lighting conditions of the one or more images, and apply the correction parameters to the one or more images to generate one or more corrected images.

In some aspects, the techniques described herein relate to a device wherein the one or more sensors of the camera system comprises at least one of a single red-green-blue (RGB) image sensor; multiple RGB image sensors, one or more RGB image sensors in combination with at least one of an infrared (IR) image sensor or ambient light sensor, or multiple RGB image sensors in a stereo camera configuration.

In some aspects, the techniques described herein relate to a device wherein the one or more processors are further configured to determine the estimate of scene lighting conditions using raw image data from the one or more sensors, preprocessed image data, or image statistics for the one or more images.

In some aspects, the techniques described herein relate to a device wherein the device further comprises a sensor controller controlling one or more operation characteristics of the one or more sensors and the one or more processors are further configured to provide the estimate of scene lighting conditions to the sensor controller to adjust the one or more operation characteristics for the one or more sensors.

In some aspects, the techniques described herein relate to a device wherein the one or more processors use a machine-learning model to determine at least one of: the estimate of scene lighting conditions, confidence values in associating the estimate of scene lighting conditions to each shading profile of multiple candidate shading profiles, an array of confidence values in associating the estimate of scene lighting conditions in multiple different locations of the one or more images, or the correction parameters.

In some aspects, the techniques described herein relate to a device wherein outputs from the machine-learning model are combined with second outputs determined by a second machine-learning model different than the machine-learning model.

In some aspects, the techniques described herein relate to a device wherein the machine-learning model and the second machine-learning model use different algorithmic approaches, including a support vector machine, a convolutional neural network, a recurrent neural network, a graph neural network, or a multilayer perceptron neural network.

In some aspects, the techniques described herein relate to a device wherein the one or more processors are further configured to reuse, adjust, smooth, or stabilize the correction parameters across the one or more images to output the one or more corrected images as a video.

In some aspects, the techniques described herein relate to a device wherein the one or more processors are further configured to compare image statistics of the one or more images to one or more predetermined thresholds, and in response to the image statistics not satisfying the one or more predetermined thresholds, estimate the scene lighting conditions or determine the correction parameters using a machine-learning model.

In some aspects, the techniques described herein relate to a method comprising determining, using a machine-learning model, an estimate of scene lighting conditions for one or more first images having spatial nonuniformity and shading effects, determining, by minimizing an error between the estimate of scene lighting conditions and actual scene lighting conditions associated with the one or more first images, tuning parameters of the machine-learning model, determining, using the machine-learning model with the tuning parameters, correction parameters based on the estimate of scene lighting conditions of one or more second images, and applying the correction parameters to the one or more second images to generate one or more corrected images.

In some aspects, the techniques described herein relate to a method wherein at least one of label-based or image-based error calculations are used to determine the tuning parameters.

In some aspects, the techniques described herein relate to a method wherein the error is minimized based on at least one of an average or maximum error value per pixel values of the one or more first images, per pixel blocks of the pixel values, or per one or more regions of interest in the one or more first images.

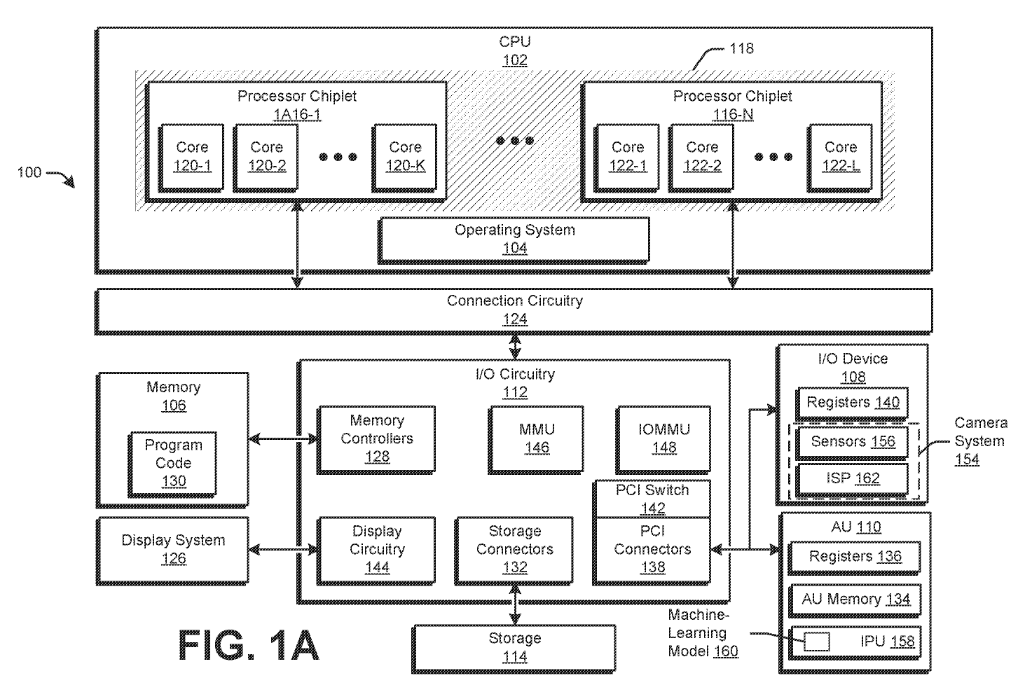

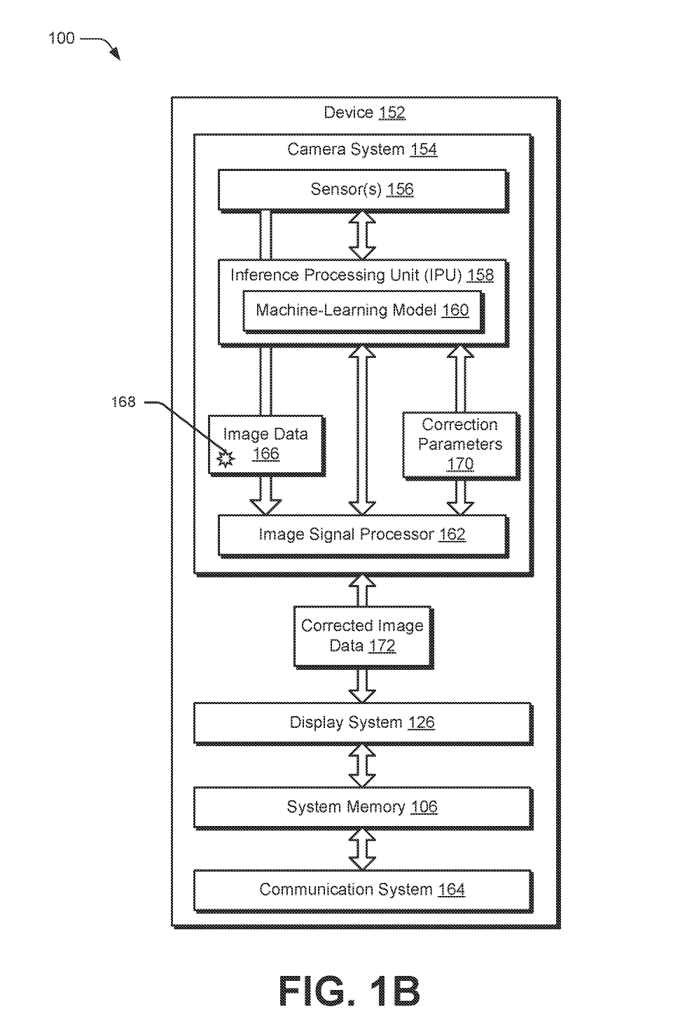

FIG. 1A is a block diagram of a processing system configured to execute one or more applications in accordance with one or more implementations.

In particular, FIG. 1A includes a processing system 100 configured to execute one or more applications, such as computing applications (e.g., machine-learning applications, neural network applications, high-performance computing applications, databasing applications, gaming applications), graphics applications, and the like. Examples of apparatuses or devices (e.g., the device 152 of FIG. 1B) in which the processing system 100 is implemented include but are not limited to a server computer, personal computer (e.g., desktop or tower computer), smartphone or another wireless phone, tablet or phablet computer, notebook computer, laptop computer, wearable device (e.g., smartwatch, augmented reality headset or device, virtual reality headset or device), entertainment device (e.g., gaming console, portable gaming device, streaming media player, digital video recorder, music or another audio playback device, television, set-top box), Internet of Things (IoT) device, automotive computer or computer for another type of vehicle, networking device, medical device or system, and other computing devices, apparatuses, or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 114) for the execution of tasks for the applications, provide an interface to I/O devices (e.g., I/O device 108) for the applications, or any combination thereof.

The CPU 102 includes one or more processor chiplets 116, which are communicatively coupled by a data fabric 118 in one or more implementations. Each processor chiplet 116, for example, includes one or more processor cores 120, 122 configured to execute one or more series of instructions concurrently, also referred to herein as “threads”, for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116.

Though the example embodiment in FIG. 6 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections that are usable to implement the data fabric 118 include but are not limited to buses (e.g., a data bus, a system, an address bus), interconnects, memory channels, and silicon vias, traces, and planes. Other example connections include optical connections, fiber optic connections, and/or connections or links based on quantum entanglement.

Additionally, within the processing system 100, the CPU 102 is communicatively coupled to an I/O circuitry 112 by a connection circuitry 124. For example, each processor chiplet 116 of the CPU 102 is communicatively coupled to the I/O circuitry 112 by the connection circuitry 124. The connection circuitry 124 includes, for example, one or more data fabrics, buses, buffers, queues, and the like. The I/O circuitry 112 is configured to facilitate communications between two or more components of the processing system 100 such as between the CPU 102, system memory 106, display system 126, universal serial bus (USB) devices, peripheral component interconnect (PCI) devices (e.g., I/O device 108, AU 110), storage 114, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 112 includes one or more memory controllers 128. The memory controllers 128, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, the memory controllers 128 are configured to manage access to the data stored at one or more memory addresses within the system memory 106, such as by CPU 102, I/O device 108, and/or AU 110.

When an application is to be executed by processing system 100, the OS 104 running on the CPU 102 is configured to load at least a portion of program code 130 (e.g., an executable file) associated with the application from, for example, a storage 114 into system memory 106. This storage 114, for example, includes a non-volatile storage such as a flash memory, solid-state memory, hard disk, optical disc, or the like configured to store program code 130 for one or more applications.

To facilitate communication between the storage 114 and other components of processing system 100, the I/O circuitry 112 includes one or more storage connectors 132 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines (e.g., inference processing unit (IPU) 150), machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 134. This AU memory 134, for example, includes any combination of one or more volatile memories and/or non-volatile memories, examples of which include caches, video RAM (VRAM), or the like. In one or more implementations, these compute units are also configured to execute these threads based on the data stored in one or more physical registers 136 of the AU 110.

To facilitate communication between the AU 110 and one or more other components of processing system 100, the I/O circuitry 112 includes or is otherwise connected to one or more connectors, such as PCI connectors 138 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCIe connectors 138 are configured to communicatively couple the I/O device 108 to the I/O circuitry 112 such that the I/O circuitry 112 is capable of routing signals to and from the I/O device 108 to one or more other components of the processing system 100.

By way of example and not limitation, the I/O device 108 includes one or more camera systems (e.g., the camera system 154 of FIG. 1B), keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 140 of the I/O device 108. In one or more implementations, such physical registers 140 are configured to maintain data (e.g., operands, instructions, values, variables) indicating one or more operations, tasks, or instructions to be performed by the I/O device 108.

In this example, the camera system 154 with the sensors 156 and the image signal processor (ISP) 162 is depicted as one of the I/O devices 108. In addition, the inference processing unit (IPU) 108 with the machine-learning model 160 is depicted as part of the AU 110. In other implementations, the AU 110 is an example of the IPU 158 with the machine-learning model 160. In variations, however, the camera system 154 (with the sensors 156 and the ISP 162) and the IPU 158 are included in and/or is implemented by one or more different components of the processing system 100, such as the CPU 102, or combined together as part of the I/O devices 108 or the AU 110.

To manage communication between components of the processing system 100 (e.g., AU 110, I/O device 108) that are connected to PCI connectors 138, and one or more other components of the processing system 100, the I/O circuitry 112 includes PCI switch 142. The PCI switch 142, for example, includes circuitry configured to route packets to and from the components of the processing system 100 connected to the PCI connectors 138 as well as to the other components of the processing system 100. As an example, based on address data indicated in a packet received from a first component (e.g., CPU 102), the PCI switch 142 routes the packet to a corresponding component (e.g., AU 110) connected to the PCI connectors 138.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display system 126, or both. The display system 126, for example, includes a cathode-ray tube (CRT) display, liquid crystal display (LCD), light emitting diode (LED) display, organic light emitting diode (OLED) display, or any combination thereof. To enable the processing system 100 to display a scene on the display system 126, the I/O circuitry 112 includes display circuitry 144. The display circuitry 144, for example, includes high-definition multimedia interface (HDMI) connectors, DisplayPort connectors, digital visual interface (DVI) connectors, USB connectors, and the like, each including circuitry configured to communicatively couple the display system 126 to the I/O circuitry 112. Additionally or alternatively, the display circuitry 144 includes circuitry configured to manage the display of one or more scenes on the display system 126 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 112 includes memory management unit (MMU) 646 and input-output memory management unit (IOMMU) 648. The MMU 146 includes, for example, circuitry configured to manage memory requests, such as from the CPU 102 to the system memory 106. For example, the MMU 146 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 146 is configured to translate the virtual address indicated in the memory request to a physical address in the system memory 106 and to fulfill the request. The IOMMU 148 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 140 of the I/O device 108, the registers 136 of the AU 110, and/or the AU memory 134, the CPU 102 issues one or more MMIO requests. Such MMIO requests each request access to read, write, fetch, or pre-fetch data residing at one or more virtual addresses (e.g., guest virtual addresses) which each represent at least a portion of the registers 140 of the I/O device 108, the registers 136 of the AU 110, or the AU memory 134, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 148 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1A. Additionally or alternatively, in at least one variation, the processing system 100 includes additional and/or different components from those depicted. The processing system 100 is configurable in a variety of ways with different combinations of components in accordance with the described techniques.

FIG. 1B is a block diagram of a non-limiting example of the processing system 100 having a device that implements a camera system and processors to mitigate spatial nonuniformity and shading effects in captured images and video using machine-learning models. Specifically, the illustrated processing system 100 depicts a device 152 with a camera system 154. Examples of device 152 include mobile devices (e.g., wearables, mobile phones, smartphones, tablets, and laptops) and webcams. As illustrated, the camera system 154 includes one or more sensors 156, an inference processing unit (IPU) 108 with a machine-learning model 160, and an image signal processor (ISP) 162 communicatively coupled with one another (e.g., via at least one bus structure, a network-on-chip, or any interconnect that enables the transfer of data between various system components described herein). Although illustrated as a single machine-learning model 160 in FIG. 1B, the IPU 158 includes multiple trained machine-learning models in other implementations.

The camera system 154 is communicatively coupled (e.g., via a bus structure or any other type of interconnect enabling transfer of image data between various device components described herein) to at least one of the display system 126, system memory 106, and communication system 164 of the device 152. In particular, the camera system 154 provides images or video data to at least one of the display system 126 (e.g., to provide a preview of a user’s video feed), system memory 106 (e.g., for storage), or the communication system 164 (e.g., for transmission as part of a videoconference). In other implementations, the display system 126, system memory 106, and communication system 164 are in another device (e.g., a laptop or desktop) but communicatively coupled (e.g., via a universal serial bus (USB) connection) to the device 152 that includes the camera system 154.

The sensors 156 obtain image data 166, which may be then processed by the camera system 154, to provide images or video for various user applications. In many instances, the image data 166 is affected by spatial nonuniformity and shading effects 168. Sensors 156 include visible light sensors (e.g., red-green-blue (RGB) image sensors), infrared (IR) image sensors, ambient light sensors, or any combination thereof. In some instances, the image sensor is a CCD (Charge-Coupled Device) or a CMOS (Complementary Metal-Oxide Semiconductor) sensor, which may include lenses and mirrors that focus the incident light. RGB sensors are generally integrated circuits sensitive to red, green, and blue light wavelengths, while IR sensors detect the thermal energy or heat emitted by objects in a scene. The image sensor converts the light incident on the sensor to an electronic signal to output digital values representing the scene. Ambient light sensors provide measurements of ambient light intensity.

Various sensor configurations are possible for the camera system 154 to implement the described techniques. In one implementation, the camera system 154 includes a single sensor 156 (e.g., one RGB sensor). Such a sensor configuration may exist in web cameras or entry-level laptops and tablets. In other implementations, the camera system 154 of more advanced devices includes multiple sensors 156 (e.g., RGB and IR sensor combinations, RGB and ambient light sensor combinations, multiple RGB sensors, and multiple RGB sensors in stereo cameras).

The inference processing unit (IPU) 158 is an electronic circuit (e.g., implemented as an integrated circuit) that performs various operations, including AI inference, on and/or using the image data 166. Example implementations of the IPU 158 include, but are not limited to, a graphics processing unit (GPU), neural network engine (NNE), neural processing unit (NPU), vision processing unit (VPU), accelerated processing unit (APU), and digital signal processor (DSP). For example, the IPU 158 is a processor that reads and executes instructions (e.g., of a program) to take advantage of the learning capabilities of the machine-learning model 160 or other AI-based techniques and the high compute powers of system-on-chip (SoC) architectures, which include AI engine(s) and other processing accelerators in some instances, to assist with the described techniques.

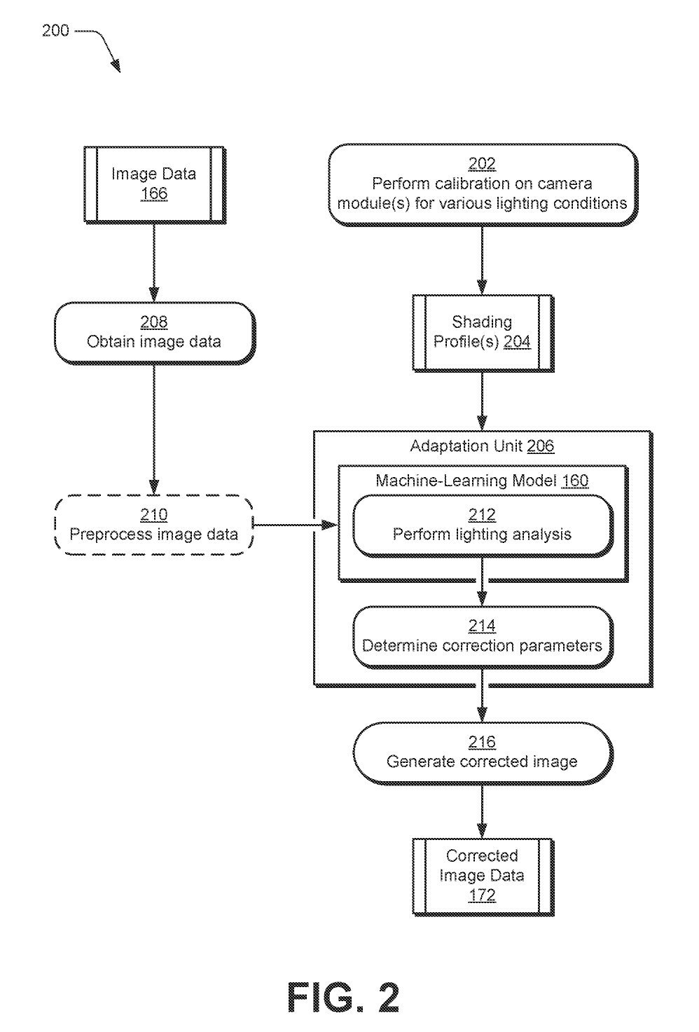

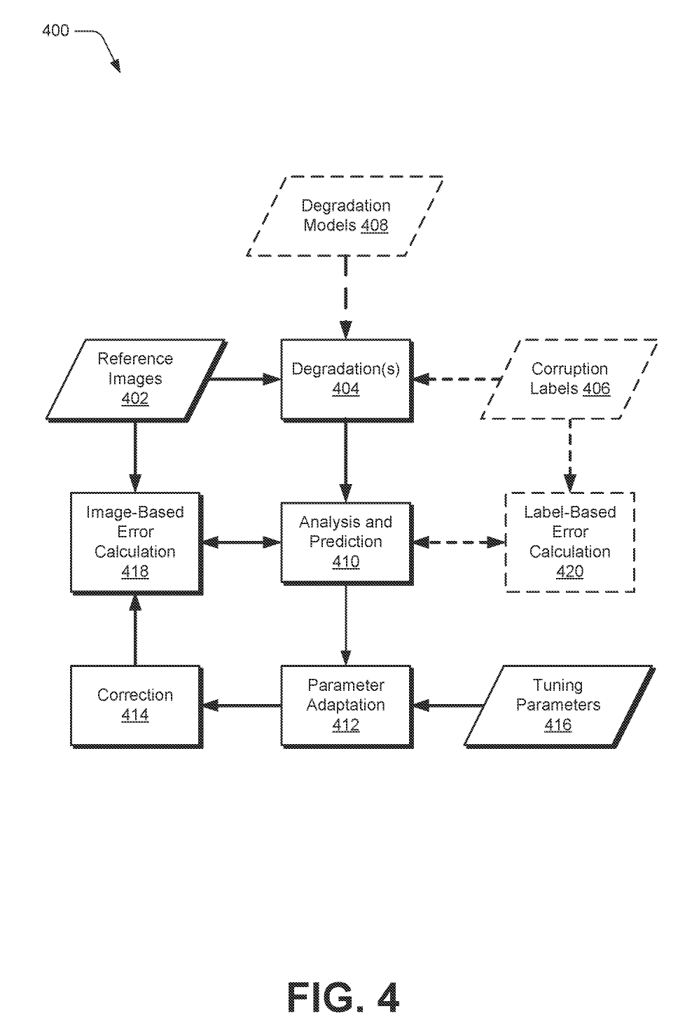

The machine-learning model 160 estimates or classifies the scene lighting conditions in the image data 166. The machine-learning model 160 uses a support vector machine, a neural network (e.g., convolutional, recurrent, graph, multilayer perceptrons), or another suitable approach to performing the described estimation and classification. Depending on design constraints and implementation strategies, the machine-learning model 160 is implemented in software or on dedicated hardware. The machine-learning model 160 is included as part of the IPU 158 in the depicted implementation. In other implementations, the machine-learning model 160 is implemented as part of the ISP 162. Training and operation of the machine-learning model 160 is described in greater detail with respect to FIGS. 2 and 4. The IPU 158, ISP 162, other circuitry, or associated camera control and parameter adaptation algorithms implemented in camera software and/or firmware then determine, based on the estimated lighting conditions and using shading profiles for different light sources, correction parameters 170 to apply to the image data 166 to reduce spatial nonuniformity and shading effects 168. The IPU 158, ISP 162, or another processor applies the correction parameters 170 to the image data 166 to generate the corrected image data 172.

In a typical camera system, the ISP 162 calibrates the image data 166, for instance, for black level, lens shading, and color correction. It also corrects defective pixels, collects image statistics for the camera control algorithms (e.g., 3A algorithms), and performs various image signal processing operations, such as white balancing, noise reduction, sharpening, gamma correction, tone mapping, color conversions, and image scaling. In the illustrated implementation of the simplified processing flow, the ISP 162 processes the image data 166 (e.g., raw image data that the sensors 156 capture) and (eventually) converts this data into corrected image data 172 (e.g., a picture or video feed) with improved spatial linearity and shading effects. In some instances, one or more processing steps from the ISP 162 may be executed on GPU, central processing unit (CPU), field programmable gate array (FPGA), and DSP. In some other instances, the ISP 162 is a processor that reads and executes instructions (e.g., of a program) to provide the image data 166 (e.g., raw data, downsampled or otherwise preprocessed data, RGB data, 3A statistics) for the machine-learning model 160 to estimate scene lighting conditions and determine the correction parameters 170. In some implementations, the ISP 162 preprocesses the image data 166 before providing inputs to the machine-learning model 160. In some instances, the machine-learning model 160 provides the output to guide the camera control and parameter adaptation algorithms, including the algorithms used to determine the sensor settings, final spatial nonuniformity and lens shading correction parameters, and other configuration and processing parameters of the IPU 158 and the ISP 162. Although the IPU 158 and ISP 162 are depicted in the illustrated example system 100 as separate components, in other variations, the IPU 158 and ISP 162 may be integrated into a single component (e.g., a single processor).

The display system 126 displays the corrected image data 172 (e.g., an image or a video feed with improved spatial uniformity). The display system 126 includes, but is not limited to, a liquid crystal display (LCD), light-emitting diode (LED), or organic light-emitting diode (OLED) display of a smartphone, tablet, laptop, monitor, or wearable device.

The system memory 106 is a device or system that stores the corrected image data 172 as an image or video. In one or more implementations, system memory 106 corresponds to semiconductor memory, where corrected image data 172 is stored within memory cells on one or more integrated circuits. In at least one example, the system memory 106 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 106 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM).

The communication system 164 transmits the corrected image data 172 to an external display (e.g., from a webcam to a laptop via a USB connection) or an external device (e.g., over the internet to another videoconference participant), as opposed to or in addition to displaying the corrected image data 172 directly in the device 152 equipped with the camera system 154.

In operation, the sensors 156 obtain image data 166 of a scene within the field-of-view of the camera system 154. For example, image data 166 includes individual images making up a video feed for videoconferencing. The image data 166 includes spatial nonuniformity and shading effects 168 that can significantly impact the user experience in camera applications and use cases, such as photography, video recording, video streaming, and videoconferencing, if such quality degradations from various lighting conditions are insufficiently mitigated in producing the corrected image data 172. Such issues often occur when a light source is incorrectly estimated or has similar correlated color temperature, but different spectral characteristics that may also include varying IR components, as the light sources used in calibration. Both spatial nonuniformity and shading effects 168 worsen in mixed lighting and dynamic environments with multiple light sources contributing to the scene lighting (e.g., indoor scenes with different artificial light sources, indoor scenes with contributions from outdoor illumination, and outdoor scenes with sunlight and shadow areas). In many camera systems, the spatial nonuniformity and shading effects 168 cannot be adequately overcome by existing scene analysis and parameter adaptation approaches, resulting in photos and videos with significant image-quality degradation. This leads to the corrected image data 172 with various processing errors, for instance, in the form of residual or new shading effects and partially corrected spatial nonuniformity.

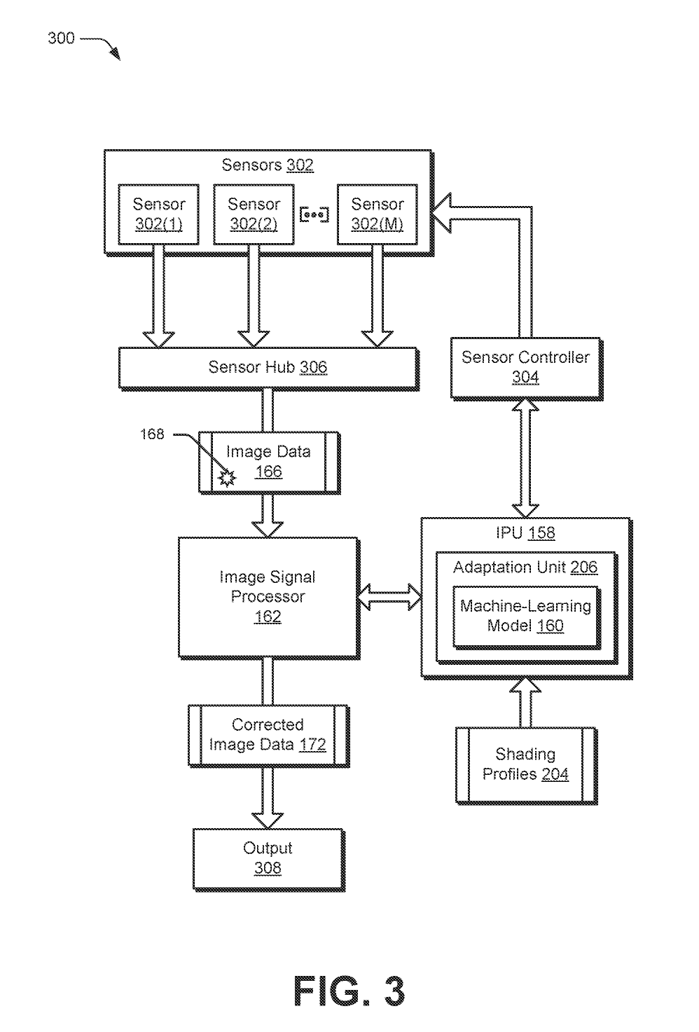

The described processing system 100 provides effective techniques to address spatial nonuniformity and shading effects 168 introduced in challenging lighting conditions (e.g., mixed lighting, dynamic environments, hard-to-characterize light sources). In particular, the ISP 162 obtains the image data 166 and provides this data or its processed version (as discussed in more detail with respect to FIG. 2) to the IPU 158. The IPU 158 then estimates, using the machine-learning model 160 applied to each image of potentially multiple images, the scene lighting as described in greater detail with respect to FIGS. 2 and 3. In this way, the scene illumination and/or difficult lighting conditions are more accurately classified, with the estimation and/or classification process being eventually sped up through AI acceleration in some scenarios. In some instances, the IPU 158 or the ISP 162 then uses the dedicated data-processing flows and data-adaptation algorithms to determine the correction parameters 170. In other instances, the correction parameters 170 are directly output by the machine-learning model 160. In either approach, the light characteristics are better detected and tracked to provide more stable and predictable camera performance with spatially uniform imagery.

FIG. 2 is a block diagram of a non-limiting example procedure 200 that illustrates techniques for improving spatial uniformity of camera captures using machine-learning models. The procedure 200 is shown as operations (or actions) performed, but not necessarily limited to the order or combinations in which the operations are shown. Any one or more operations may be repeated, combined, or reorganized to provide other algorithms. In portions of the following discussion, reference may be made to the systems and components of FIGS. 1A and 1B by example. The procedure 200 is not limited to performance by the mentioned systems and components.

In camera systems, spatial nonuniformity and shading effects are generally addressed using calibration, adaptation, and correction steps. Camera systems can employ several different techniques or strategies in each step. Typical techniques for each step are described in the following paragraphs for procedure 200 to highlight the advantages of the described systems and techniques in the adaptation step to improve spatial uniformity for camera imagery.

To begin, calibration of one or more camera modules or systems is performed for various lighting conditions (block 202). In the calibration step, shading profiles 204 are determined for simulated lighting conditions in controlled laboratory environments, independent of environmental influences and scene changes. Flat-field images are captured using an integrating sphere or a diffuser in light booth and light panel setups. In some instances, the calibration data can also include flat-field images captured in the field using the diffuser or other suitable technique. The images are subject to preprocessing to remove the pedestal (offset) and outliers (e.g., defective pixels) and linearize the data. The images are then divided into non-overlapping blocks of uniform size, such as 64x64, 128x128, or some other power of two for efficient implementation, although other dimensions, including rectangular-shaped blocks, can also be used in some instances. Each block is represented by its mean, trimmed-mean, or other suitable value determined per color channel of the calibration images. The camera system determines, for each simulated lighting condition or calibration light source, the correction parameters of a shading profile 204 as the ratio between the largest mean value (e.g., typically in the optical center) or some other reference value and all other mean values, thus producing a grid of correction gains or factors (collectively referred to as the shading profile 204). Correction gains with the smallest values are typically in the image center, and the largest values are generally located at the image boundaries and corners.

The calibration procedure (block 202) is repeated for several (e.g., typical) camera modules to increase the robustness of correction by combining the results from multiple modules. Alternatively, the shading profiles 204 are generated using the obtained block mean values or correction gains via a parametric model to reduce the memory or line buffer requirements and simplify the correction step for some hardware implementations. Some calibration approaches employ hybrid solutions that leverage both the correction grids and the parametric models to separately track higher and lower frequencies in the shading profile 204 or to meet implementation constraints (e.g., gain limits in one or both sub-routines). In other approaches, the calibrated correction gains may be adjusted to fine-tune the correction effect according to predetermined criteria or strategy. In summary, the calibration step generates shading profiles 204 in certain desired ways to cover typical lighting conditions, address module-to-module variations, and mitigate the impact of potential outliers and noise in the image data.

The machine-learning model 160 is trained to recognize subtle patterns associated with different scene lighting conditions in image data. Namely, using supervised learning and image data collected in controlled lighting and field-test scenarios, the machine-learning model 160 is optimized to determine appropriate model parameters (e.g., weights, biases, and hyperparameters) for classifying scene lighting conditions in real-time during the operation of the camera system 154. In some instances, the training process includes all light sources used to generate the shading profiles 204. In other instances, the coverage of lighting conditions in machine learning and sensor calibration differs, subject to their own design requirements and performance targets (e.g., mixed lighting scenarios synthetically generated for machine learning using two or more shading profiles).

In some implementations, the machine-learning model 160 is continually trained using incremental training data sets. After initially training the machine-learning model 160 to classify scene lighting conditions according to the shading profiles 204, the machine-learning model 160 can execute additional training operations using new training data to classify lighting conditions associated with new light sources or lighting conditions. However, instead of starting with a random set of weights, the machine-learning model 160 executes the training operation using the previously determined weights. In this way, the machine-learning model 160 continually builds upon and fine-tunes its weights as new training data becomes available.

Training of the machine-learning model 160 may occur offline or online. In offline training (e.g., batch learning), the machine-learning model 160 is trained on a static training data set. In online training, the machine-learning model 160 is continuously trained (or re-trained) as new training data become available (e.g., while the machine-learning model 160 is used to perform the desired estimation, classification, and/or correction operations). The machine-learning model 160 is generally trained offline (e.g., at a training computing system which includes a model trainer) and then deployed to one or more camera systems to perform the inference. The training computing system is generally separate from the camera system that applies the machine-learning model 160 to the image data 166.

In the adaptation step (blocks 212 and 214), a camera system performs image analysis and estimates at runtime the actual scene lighting conditions in the captured image data. For example, the image data 166 is received or obtained (block 208) by a camera system (e.g., the camera system 154). The image data 166 includes raw image data from the sensors 156, RGB data, intermediate data from the ISP pipeline (e.g., after black level and defective pixel correction), 3A statistics, ambient light sensor data, or a combination thereof. In some implementations, the camera system 154 preprocesses the image data 166 (block 210) by applying downscaling, conversion, normalization, and/or other suitable methods to prepare the data for AI training and inference.

In some existing systems, correction parameters are estimated directly from the actual image or its downscaled version. This approach usually involves frequency analysis to select only regions or statistics associated with low-frequency image contents to reduce estimation errors. Unfortunately, the heuristic nature of such adaptive approaches, coupled with the varying image content and quality, the downscaling factors, the number of suitable values, and their spatial distribution, has a significant performance impact, often leading to large estimation errors, temporal instabilities, and video flickering effects. These adaptation approaches are generally complex, slow, and impractical for real-time camera applications, such as videoconferencing and streaming.

In the described systems and techniques, an adaptation unit 206 employs the machine-learning model 160 to mitigate spatial nonuniformity and shading effects 168 in the image data 166. The adaptation unit 206 is implemented in software, firmware, or a combination thereof to perform light analysis (block 212). In particular, the adaptation unit 206 uses the machine-learning model 160 to accurately determine light attributes, including the correlated color temperature or brightness, associated with the image data 166. In one implementation, the adaptation unit 206 is distributed among the IPU 158 and the ISP 162 of FIG. 1B. In other implementations, the adaptation unit 206 is located on the IPU 158 or the ISP 162. In yet another implementation, the adaptation unit or at least some of its components is implemented in camera software or firmware.

The machine-learning model 160 includes one or more artificial neural networks, which include a group of connected nodes (e.g., neurons or perceptrons) organized into one or more layers. Once training is completed, the machine-learning model 160 is deployed in the adaptation unit 206 in an inference stage. In the inference stage, the machine-learning model 160 receives the image data 166 or its preprocessed variant (output from block 210) as input and outputs predictions of which shading profiles 204 are associated therewith.

In particular, the machine-learning model 160 implements a classification model, a regression model, or their combination to determine one or more shading profiles 204 as suitable candidates to approximate and correct spatial nonuniformity and shading effects in the image data 166. In some instances, the machine-learning model also indicates probabilities associated with the image data 166 being associated with different shading profiles 204. In the depicted procedure 200, the machine-learning model 160 employs the convolutional neural network to generate shading profile probabilities or confidence scores, indicating likelihood of the image data 166 or a portion thereof being associated with the shading profiles 204. For example, the confidence scores indicate a first probability that the image data 166 is associated with a first shading profile and a second probability that the image data 166 is associated with a second shading profile. The machine-learning model 160 then classifies the image data 166 to select the shading profile 204 having the highest confidence score. In other implementations, the machine-learning model 160 classifies the image data 166 with a combination of shading profiles 204 that meet threshold criteria (e.g., a particular number of shading profiles with the highest confidence scores or all shading profiles with a confidence score higher than a predetermined threshold).

Based on the estimated scene lighting conditions, the adaptation unit 206 determines correction parameters to apply to the image data 166 (block 214). In particular, the adaptation unit 206 uses parameter adaptation algorithms to select and adjust the suitable shading profile (e.g., a collection of correction gains) from the calibrated set of shading profiles 204 stored in memory. In some design strategies, the adaptation unit 206 selects several closest shading profiles 204 to calculate final correction parameters, which generally involves interpolation guided by some quantifiable differences (e.g., correlated color temperature, white point, brightness differences, and IR characteristics) between the calibrated and detected scene lighting conditions to adaptively determine interpolation weights to control the contributions of candidate shading profiles 204. Interpolation ensures that the shading profiles 204 closer to the detected scene lighting condition contribute more to the final correction parameters.

In the correction step (block 216), the ISP 162 generates corrected image data 172 using the correction parameters. In particular, the ISP 162 uses the correction parameters 170 to configure the relevant correction block(s) in the image processing pipeline. In some instances, this process also involves correction grid resolution (shading profile dimensions), correction factors, shading profile approximation, and numerical precision settings. In some implementations, luminance and color shading are handled separately. Using grids of correction coefficients, the correction gain in each pixel location is interpolated (e.g., using the spatial distance between the actual pixel and the grid coefficients) from several spatially nearest grid coefficients and then multiplied with the pixel value to produce the corrected value in the corrected image data 172. Alternatively, the correction factor in each pixel location can be calculated from the pixel coordinates using a parametric model or a look-up table. In other implementations, the corrected pixel values are adjusted with a scaling factor aligned with the precision of calibrated gains. The ISP 162 repeats this process for each color channel or image plane. As a result of procedure 200, the corrected image data 172 has a more natural and uniform appearance (i.e., improved spatial uniformity and reduced shading effects) than the image data 166.

In conventional camera systems, procedure 200 is challenging or ineffective in complex scenes and lighting scenarios, such as low-light and mixed-lighting conditions. Because calibration cannot generate shading profiles 204 for all real-life situations (e.g., especially for varying lighting conditions and mixed lighting), adapting the shading profiles 204 to the actual scene lighting conditions in runtime (blocks 212 and 214) is often the most critical step in addressing spatial nonuniformity and shading effects. However, conventional light source estimation solutions are prone to errors in various situations, including where the actual illuminants are similar to, but not completely matching those used to generate the shading profiles 204 or when the scene illumination comprises multiple illuminants or light sources. The described techniques address these drawbacks by taking advantage of the learning capabilities of machine-learning models and the high computing power of AI accelerators and other processors present in system-on-chip (SoC) architectures.

FIG. 3 is a block diagram of a non-limiting example system 300 showing device components employed to mitigate spatial nonuniformity and shading effects in camera captures using machine-learning models. The sensors 156, IPU 158, and ISP 162 are illustrated in FIG. 3 with greater detail than in FIG. 1B.

The sensors 156 include one or more sensors 302, examples of which are illustrated as sensor 302(1), sensor 302(2), and sensor 302(M), where M is a positive integer. As described above, sensor 302 includes an RGB image sensor, ambient light sensor, IR image sensor, or any combination thereof. A sensor controller 304 controls the operation and image-capturing settings of each sensor 302. For example, the sensor controller 304 indicates the timing and length of data capture by the sensors 302. Depending on sensor module capabilities, the sensor controller 304 can also determine analog and digital gains, aperture, and autofocus settings. In some implementations, one or more processors (e.g., IPU 158 and/or ISP 162) are configured to provide the estimated scene lighting conditions to the sensor controller 304 to adjust the desired operation characteristics for one or more sensors 302 based on the estimated scene lighting conditions. In some instances, one or more processors are configured to use the estimated scene lighting conditions to adjust the operation characteristics of IPU 158 and/or ISP 162, including the parameter configurations of software and hardware algorithms other than the algorithms for correcting spatial nonuniformity and shading effects.

The system 300 produces high-quality images using a single RGB sensor by utilizing the inference capabilities of the machine-learning model 160. However, system 300 also provides further processing accuracy and efficiency using information from multiple sensors 302 to influence the inference and parameter adaptation process. Accordingly, in some implementations, the single RGB sensor is substituted with a combination of RGB, ambient light, and IR image sensors or multiple RGB sensors in a stereo camera configuration. In some instances, the system 300 leverages more than one machine-learning model 160, regardless of the number of employed sensors.

Each sensor 302 provides data (e.g., raw data values) to a sensor hub 306. The sensor hub 306 aggregates the data from each sensor 302 into the image data 166, which is then provided to the ISP 162. As previously discussed, the image data 166 generally includes spatial nonuniformity and shading effects 168. In one implementation, the sensors 302, sensor controller 304, and sensor hub 306 are included in the same device as the IPU 158 and the ISP 162 (e.g., a front-facing camera in a laptop). In other implementations, these components or some of these components are included in a device separate from the IPU 158 or the ISP 162.

As discussed with respect to FIG. 2, the ISP 162 provides the image data 166 or preprocessed image data (e.g., from block 210) to the IPU 158. For example, the preprocessing includes pedestal removal (black level correction), defective pixel correction, noise reduction, outlier removal, downscaling, block-based averaging, or a combination thereof. In some implementations, the preprocessing also includes conversion, normalization, and/or other suitable methods to prepare the data for training and inference. Preprocessing by the IPU 158 or the ISP 162 enhances the inputs and/or makes the inputs otherwise suitable for the machine-learning model 160, thereby improving the efficiency or accuracy of the inference process.

The machine-learning model 160 of the adaptation unit 206 takes the input image data and performs inference operations to estimate scene lighting conditions in the image data and determine correction parameters. In scenes illuminated with a single light source, one estimate by the machine-learning model 160 indicates the shading profile 204 (e.g., calibrated lighting condition) closest to the actual scene lighting condition. In another implementation, the training is approached as a multi-classification problem, and the machine-learning model 160 outputs the confidence value for each shading profile 204. In some instances, the machine-learning model 160 outputs one or more confidence maps (e.g., a grid or array of confidence values) that include local predictions per pixel location, blocks or subsets of pixel values, or one or more regions of interest. Confidence maps significantly improve the correction output for more complex scenes with multiple light sources, mixed lighting, and/or dynamic illumination changes. Alternatively, the machine-learning model 160 directly generates spatial nonuniformity profile(s) or correction parameters for the input image to eliminate the need for lens-shading calibration.

The IPU 158 provides the inference outputs, including adjustments made to or using the machine-learning model’s output by the adaptation unit 206 in some implementations, to ISP 162 to generate the corrected image data 172. The ISP 162 then provides the corrected image data 172 to an output 308, which includes the display system 126, memory 106, communication system 164, or a combination thereof.

FIG. 4 is a block diagram of a non-limiting example procedure 400 that illustrates techniques to optimize the training of the machine-learning model 160 for spatial uniformity improvements in digital images and video. Procedure 400 illustrates refined cost functions to enhance the estimation performance (e.g., accuracy) of the machine-learning model 160.

As described above, training the machine-learning model 160 involves optimizing the model’s parameters using a training dataset. In some instances, the training dataset includes reference images 402 with existing spatial nonuniformity and shading effects. Degradation (block 404) adds corruption labels 406 to each reference image 402 to indicate the type and severity of the degradation for training while keeping the image data unchanged. The model learns by minimizing the label-based error (block 420) between the output of analysis and prediction (block 410) and the corruption labels 406.

Alternatively, the training data is created from synthetic or real-life images with good spatial uniformity. These images are then adjusted or degraded (block 404) using a degradation model 408 to produce desired degradations, including spatial nonuniformity and shading effects. The degradation model 408 (e.g., shading profiles with spatial nonuniformity) is obtained using sensor characterization in controlled lighting environments to generate the corrupted images (e.g., with shading effects) for the training dataset. In some implementations, the degradation model 408 also includes white balancing, color correction, noise modeling, and/or other desired operations to mimic image data at a point of interest in the data pipeline.

The machine-learning model then performs analysis and predictions (block 410) on the reference images 402 or their degraded versions. The process continues with parameter adaptation (block 412) and correction (block 414) on the reference images 402 or their degraded versions similar to the techniques described with respect to FIGS. 1 through 3. In some implementations, tuning parameters 416, based on the test or validation training data set, are used to improve the parameter adaptation (block 412) of the trained model.

The model learns by minimizing the error between the ideal images (e.g., reference images 402 with good spatial uniformity) and the corrected images (block 414). The model is evaluated using performance metrics related to prediction accuracy, shading errors, and/or spatial uniformity on label-to-label, label-to-image, and/or image-to-image bases. For example, as previously discussed in relation to the training using reference images with real spatial nonuniformity and shading effects, the training involves label-based error calculations (block 420) by comparing the predicted lighting conditions to the corruption labels 406. In other instances, the training involves image-based error calculations (block 418) by comparing the corrected image data (for a degraded image) to the corresponding reference image data. Depending on the training strategy and objectives, these cost functions assess average or maximum color errors across the image, per blocks of image values, or regions of interest (e.g., image center and corners). In some instances, the cost functions reflect the similarity (or the lack of it) between the reference location (e.g., image center) and other image locations for a particular representative image value at those locations. In other instances, the cost function also combines chromatic and luminance errors to minimize color and brightness shading effects simultaneously. In some other instances, the cost function reflects the distribution of spatial uniformity errors across the image. Accordingly, the model parameters are adjusted (e.g., using optimization algorithms such as gradient descent) during training to minimize the difference between its predictions and the actual outcomes, preparing the model to make inferences on new, unseen scene lighting conditions. The training process is repeated for all images in the training dataset by minimizing the aggregated error(s). In some instances, the training and validation process may also involve subjective criteria of perceived image quality to evaluate and compare spatial uniformity and shading effects in images and video.

Depending on the design preferences or implementation constraints (e.g., in device 152), the AI training and inference stages of procedure 400 using one or more machine-learning models 160 are performed for each image plane (e.g., color channels, color planes, luminance planes, and/or images from multiple sensor configurations) separately or using a multi-channel approach to leverage cross-channel correlation, thus achieving higher prediction accuracy for the machine-learning model 160. In some implementations, the so-called hyperparameters (e.g., learning rate, number of iterations) are also tuned to obtain a model with optimal performance.

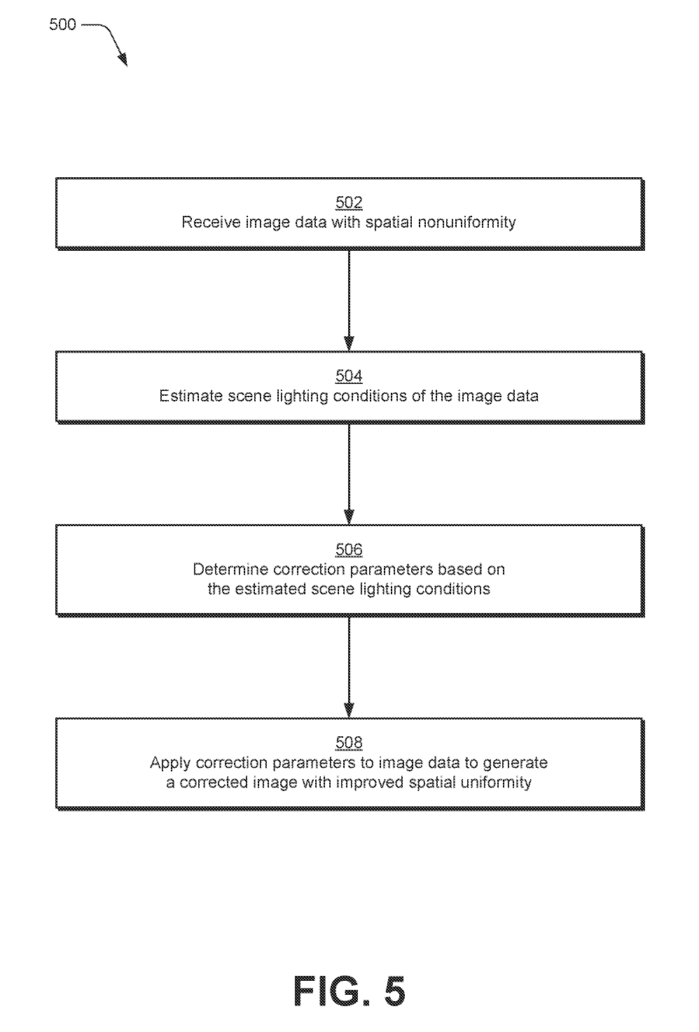

FIG. 5 is a block diagram of a non-limiting example procedure 500 that illustrates a stepwise algorithm for improving spatial uniformity in digital images and video using machine-learning models. The procedure 500 is shown as operations (or actions) performed, but not necessarily limited to the order or combinations in which the operations are shown herein. Any one or more operations may be repeated, combined, or reorganized to provide other algorithms. In portions of the following discussion, reference may be made to the systems and components of FIGS. 1 through 4, reference to which is made by example. The algorithm is not limited to performance by the mentioned systems and components.

To begin, image data for one or more images with spatial nonuniformity are received (block 502). The ISP 162, for instance, receives the image data 166 with spatial nonuniformity and shading effects 168 from the sensors 156.

Scene lighting conditions of the image data are then estimated (block 504). For example, the machine-learning model 160 estimates scene lighting conditions in image data 166 using at least one shading profile from the shading profiles 204, which were generated during the sensor calibration and/or for the purpose of training of the machine-learning model 160. In this inference phase, the machine-learning model 160 analyzes new data (e.g., the image data 166) and predicts which shading profiles 204 (associated with calibrated scene lighting conditions) most closely match the actual scene lighting conditions in the new data. In some implementations, the machine-learning model 160 produces one or more confidence values for each shading profile 204 by treating the shading profiles 204 collectively as a multi-classification problem.

In some implementations, the machine-learning model 160 is used only in challenging scene-lighting conditions or when significant scene-lighting changes are detected to reduce power consumption by the IPU 158 and/or other suitable processing units. Such conditions are identified by performing heuristic analysis of the image data 166 by comparing predetermined thresholds with image statistics (e.g., color ratios, saturation pixel counts, IR and color channel averages) using actual image data or representative data thereof (e.g., 3A statistics or downsampled images). For example, if the image statistics or representative data thereof satisfy the predetermined thresholds, the correction parameters from one or more previous images are reused until the scene-lighting changes change by a certain degree. In other implementations, the correction parameters for the image are determined directly from the image data or a downscaled version of the image data without using the machine-learning model 160 in response to the image statistics or representative data thereof satisfying the predetermined thresholds.

Correction parameters are determined based on the estimated scene lighting conditions (block 506). The machine-learning model 160 or the adaptation unit 206, for instance, determines correction parameters based on the estimated scene lighting conditions.

In this subsequent parameter adaptation step, the machine-learning model 160 or the adaptation unit 206 uses the confidence values associated with each shading profile 204 to determine optimal correction parameters (or estimated scene lighting conditions) for the actual image (e.g., the image data 166). In one implementation, the final correction parameters correspond to the shading profile 204 associated with the highest confidence value. In another implementation, several shading profiles 204 associated with the highest confidence values are averaged to generate the final correction parameters (e.g., the shading profiles 204 associated with the five largest confidence values). Alternatively, the shading profiles 204 associated with confidence values larger than a predetermined threshold value are averaged to generate the final correction parameters. In yet another implementation, the contributions of shading profiles to the final output (e.g., estimated scene lighting conditions or final correction parameters) are determined by applying adaptive weights to each shading profile 204. The adaptive weights are determined by normalizing particular confidence values (e.g., several largest confidence values or the confidence values above a predetermined threshold value) with the sum of the particular confidence values. In this way, combining shading profiles to generate the final correction parameter involves weight calculations to guide adaptive averaging of shading profiles 204. In other scenarios, this adaptation process employs other suitable functions, including trimmed mean, thresholding, exponential, and power functions, to provide additional design flexibility and performance enhancement in determining the interpolation weights and/or final correction parameters. In some instances, the machine-learning model 160 produces at least one spatial map (e.g., confidence map) or array (e.g., grid) of confidence values to combine shading profiles 204 using different weights in each pixel location.

Alternatively, the machine-learning model 160 estimates the two-dimensional spatial nonuniformity profile(s) or directly outputs the correction parameters rather than lighting condition estimates. The dimensions of a confidence map or a correction parameter array produced by the machine-learning model 160 are arbitrary; however, matching the dimensions of shading profiles 204 and/or the configuration of the correction block in the IPU 158 or the ISP 162 provides processing time and power consumption savings.

In some instances, the output of one machine-learning model is combined with the output of another machine-learning model and/or traditional lighting condition estimation and parameter adaptation schemes. This can be done via arbitration, voting, weighted averaging, or other suitable approach to leverage different learning and estimation capabilities of employed solutions. For instance, a first machine-learning model is a support vector machine while a second machine-learning model uses a convolutional neural network to perform training and inference. In some instances, multiple machine-learning models use the same AI approach (e.g., convolutional networks), but varying in configuration (e.g., network size and topology), training (e.g., cost function, optimization method, training dataset), and so on. In some implementations, the output (e.g., estimated scene lighting conditions, confidence values, and/or correction parameters) of the machine-learning model 160 also undergoes temporal filtering, reuse, adjustment, and/or stabilization (e.g., implemented via dead zones and/or thresholding of the differences in estimates) to avoid flickering effects and ensure smooth transitions between consecutive images or video frames.

In some implementations, confidence maps and correction parameters generated by the machine-learning model 160 are enhanced by spatial filtering and morphological processing to suppress local estimation errors. In other implementations, the confidence maps are also subject to nonlinear mapping to emphasize contributions of the most relevant shading profiles 204 in parameter adaptation.

The correction parameters are then applied to the image data to generate a corrected image with improved spatial uniformity (block 508). For example, the ISP 162 applies the correction parameters to the image data 166 to generate corrected image data 172. The corrected image data 172 is then output to the display system 126, memory 106, or communication system 164.

Many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 152, camera system 154, sensors 156, IPU 158, machine-learning model 160, ISP 162, and adaptation unit 206) are implemented in any of a variety of different manners, such as hardware circuitry, software or firmware executing on a programmable processor, or any combination of two or more of hardware, software, and firmware.

In one or more implementations, the methods and procedures provided herein are implemented in a computer program, software, or firmware incorporated in a non-transitory computer-readable storage medium for execution by a computer or a processor. Examples of non-transitory computer-readable storage mediums include read-only memory (ROM), random-access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Instead, the specific features and acts are examples of implementing the claimed subject matter.

What is claimed is:

1. An apparatus comprising:
one or more processors configured to:
determine, for one or more images, correction parameters to mitigate spatial nonuniformity and shading effects based on an estimate of scene lighting conditions of the one or more images; and
apply the correction parameters to the one or more images to generate one or more corrected images.

2. The apparatus of claim 1, wherein a machine-learning model determines the estimate of scene lighting conditions of the one or more images by associating the scene lighting conditions to multiple shading profiles and providing a confidence value for each shading profile of the multiple shading profiles.

3. The apparatus of claim 2, wherein the correction parameters are determined based on at least one of:
a subset of the multiple shading profiles with highest confidence values; or
the multiple shading profiles having confidence values above a predetermined threshold value.

4. The apparatus of claim 2, wherein at least one of the estimate of scene lighting conditions, confidence values, or the correction parameters determined by the machine-learning model are combined with at least one of another estimate of scene lighting conditions, other confidence values, or other correction parameters, respectively, determined by a second machine-learning model different from the machine-learning model.

5. The apparatus of claim 2, wherein the correction parameters are determined by applying adaptive weights to each correction parameter associated with each shading profile of a subset of the multiple shading profiles, the adaptive weights obtained by normalizing each confidence value with a sum of confidence values for the subset of the multiple shading profiles.

6. The apparatus of claim 1, wherein the correction parameters are applied to the one or more images per pixel location or per one or more blocks of pixel values of the one or more images.

7. The apparatus of claim 1, wherein:
the one or more processors comprise multiple processors; and
a single processor of the multiple processors employs a machine-learning model to determine the estimate of scene lighting conditions or determine the correction parameters.

8. The apparatus of claim 1, wherein the one or more processors are further configured to:
compare image statistics of the one or more images to one or more predetermined thresholds; and
in response to the image statistics satisfying the one or more predetermined thresholds, determine the estimate of scene lighting conditions and determine the correction parameters using a machine-learning model.

9. A device comprising:
a camera system with one or more sensors and one or more processors, the one or more processors being collectively configured to:
obtain image data for one or more images from the one or more sensors;
determine, for the one or more images, correction parameters to address spatial nonuniformity and shading effects based on an estimate of scene lighting conditions of the one or more images; and
apply the correction parameters to the one or more images to generate one or more corrected images.

10. The device of claim 9, wherein the one or more sensors of the camera system comprises at least one of:
a single red-green-blue (RGB) image sensor;
multiple RGB image sensors;
one or more RGB image sensors in combination with at least one of an infrared (IR) image sensor or ambient light sensor; or
multiple RGB image sensors in a stereo camera configuration.

11. The device of claim 9, wherein the one or more processors are further configured to determine the estimate of scene lighting conditions using raw image data from the one or more sensors, preprocessed image data, or image statistics for the one or more images.

12. The device of claim 9, wherein:
the device further comprises a sensor controller controlling one or more operation characteristics of the one or more sensors; and
the one or more processors are further configured to provide the estimate of scene lighting conditions to the sensor controller to adjust the one or more operation characteristics for the one or more sensors.

13. The device of claim 9, wherein the one or more processors use a machine-learning model to determine at least one of:
the estimate of scene lighting conditions;
confidence values in associating the estimate of scene lighting conditions to each shading profile of multiple candidate shading profiles;
an array of confidence values in associating the estimate of scene lighting conditions in multiple different locations of the one or more images; or
the correction parameters.

14. The device of claim 13, wherein outputs from the machine-learning model are combined with second outputs determined by a second machine-learning model different than the machine-learning model.

15. The device of claim 14, wherein:
the machine-learning model and the second machine-learning model use different algorithmic approaches, including a support vector machine, a convolutional neural network, a recurrent neural network, a graph neural network, or a multilayer perceptron neural network.

16. The device of claim 9, wherein the one or more processors are further configured to reuse, adjust, smooth, or stabilize the correction parameters across the one or more images to output the one or more corrected images as a video.

17. The device of claim 9, wherein the one or more processors are further configured to:
compare image statistics of the one or more images to one or more predetermined thresholds; and
in response to the image statistics not satisfying the one or more predetermined thresholds, estimate the scene lighting conditions or determine the correction parameters using a machine-learning model.

18. A method comprising:
determining, using a machine-learning model, an estimate of scene lighting conditions for one or more first images having spatial nonuniformity and shading effects;
determining, by minimizing an error between the estimate of scene lighting conditions and actual scene lighting conditions associated with the one or more first images, tuning parameters of the machine-learning model;
determining, using the machine-learning model with the tuning parameters, correction parameters based on the estimate of scene lighting conditions of one or more second images; and
applying the correction parameters to the one or more second images to generate one or more corrected images.

19. The method of claim 18, wherein at least one of label-based or image-based error calculations are used to determine the tuning parameters.

20. The method of claim 18, wherein the error is minimized based on at least one of an average or maximum error value per pixel values of the one or more first images, per pixel blocks of the pixel values, or per one or more regions of interest in the one or more first images.
